(19) United States
(12) Patent Application Publication
(10) Pub. No.: US 2011/0000355 A1
(43) Pub. Date: Jan. 6, 2011

(54) Multi-Bandsaw Machine

(75) Inventor: Shin Cheng Lin, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: KINIK COMPANY, Taipei (TW)

(21) Appl. No.: 12/496,344

(22) Filed: Jul. 1, 2009

(51) Int. Cl. B26D 1/46; B26D 1/48

(52) U.S. Cl. 83/796; 83/808; 83/814

(57) ABSTRACT

A multi-bandsaw machine includes several bandsaws, for cutting a material into a plurality of plates in a single process. At least one side edge of each bandsaw has a plurality of diamond grits, and the bandsaws rotate in a single direction on the multi-bandsaw machine, so as to cut the material with the diamond grits and form a cutting notch on the material. The cutting notch has a depth to kerf ratio at least larger than 100:1 during the process of cutting the material with the diamond grits in each hour.

### BACKGROUND OF THE INVENTION

1. Field of Invention

The present invention relates to a bandsaw machine, and more particularly to a multi-bandsaw machine having several bandsaws, capable of cutting wood, stone, or other materials into a plurality of plates in a single process.

2. Related Art

A bandsaw machine is mainly used for cutting in metalwork or carpentry. Wood, stone, or other materials are cut by the bandsaw machine into plates with a certain thickness, so as to be easily conveyed or used by workers. Generally, the bandsaw machine is formed by a machine body and a cutter mounted on the body. The cutter has two symmetrically disposed bandsaw wheels, and a bandsaw winds around the bandsaw wheels. The two bandsaw wheels are spaced by a span with a predetermined length, and the two ends of the bandsaw are respectively fit on the two bandsaw wheels.

Meanwhile, a conveyor belt is disposed near the bandsaw machine at a position corresponding to the bandsaw. The conveyor belt is used for delivering wood, stone, or other materials to be cut. Taking a cutting process of a stone material for example, when the bandsaw machine is adapted to cut the stone material, the bandsaw wheels are driven to rotate by a motor, so as to force the bandsaw to revolve at a high speed between the two bandsaw wheels.

Then, the worker starts the conveyor belt to deliver the stone material to the bandsaw, and the bandsaw in high-speed revolving cuts the stone material into a plate with a predetermined thickness. However, in the configuration of the bandsaw machine, as only one bandsaw is provided, a single piece of stone material is obtained by cutting each time, and the delivering distance of the conveyor belt must be controlled in order to obtain stone plates at the same thickness. Thereby, it is impossible to produce a large number of stone plates by cutting within a certain period of time, so that the producing efficiency of the stone plates is low and the manufacturing cost is greatly increased.

### SUMMARY OF THE INVENTION

Accordingly, the present invention is a multi-bandsaw machine capable of improving the design of a common bandsaw machine having only one bandsaw, so as to solve the problem in the prior art that only a single piece of wood, stone, or other materials is obtained by cutting in a single process, and meanwhile the thickness of the cut plate is difficult to control, which not only affects the cutting efficiency of the process, but also increases the manufacturing cost.

The present invention provides a multi-bandsaw machine for cutting a material into a plurality of plates in a single process. The multi-bandsaw machine comprises several bandsaws, and the bandsaws move in a single direction on the multi-bandsaw machine. At least one of two opposite side edges of each bandsaw is provided with a plurality of diamond grits, so that the bandsaws cut the material with the diamond grits and form a cutting notch on the material. The cutting notch has a depth to kerf ratio at least larger than 100:1 during the process of cutting the material with the diamond grits in each hour.

The multi-bandsaw machine provided by the present invention has several bandsaws, and is capable of cutting metal, wood, stone, or other materials into a plurality of plates in a single process, in which the obtained plates may have the same thickness or different thicknesses. Thereby, the cutting efficiency is enhanced and the operating times of the cutting process is reduced, so as to lower the operating cost of the process. Moreover, in the cutting process of a material, as the cutting notch made by the bandsaws on the material has a depth to kerf ratio maintained larger than 100:1 in each hour, the scraps produced in forming the cutting notch are reduced, thus saving the material and lowering the manufacturing cost of the plates.

The description on the content of the present invention above and the description on the embodiments below are used to exemplify and explain the spirit and principle of the present invention, and provide further explanation on the claims of the present invention.

### BRIEF DESCRIPTION OF THE DRAWINGS

The present invention will become more fully understood from the detailed description given herein below for illustration only, and thus are not limitative of the present invention, and wherein:

FIG. 1 is a schematic front view of a first embodiment of the present invention;

FIG. 2 is a schematic side view of the first embodiment of the present invention;

FIG. 3A is a schematic structural view of a bandsaw wheelset according to the first embodiment of the present invention;

FIG. 3B is a schematic front view of guide wheelsets according to the first embodiment of the present invention;

FIG. 3C is a schematic side view of bandsaw wheels having different distances according to the first embodiment of the present invention;

FIG. 4A is a schematic bottom view of bandsaw wheels having the same distance according to the first embodiment of the present invention;

FIG. 4B is a schematic bottom view of bandsaw wheels having different distances according to the first embodiment of the present invention;

FIG. 5 is a schematic side view of the operation in the first embodiment of the present invention;

FIG. 6 is a partial schematic view of a cutting notch on a stone material according to the first embodiment of the present invention;

FIG. 7 is a schematic side view of a second embodiment of the present invention; and

FIG. 8 is a schematic front view of the second embodiment of the present invention.

### DETAILED DESCRIPTION OF THE INVENTION

The multi-bandsaw machine provided by the present invention is used to cut metal, wood, and stone materials. In the embodiments of the present invention, a cutting process of a stone material is taken as an example for illustration, and the present invention is not limited thereto.

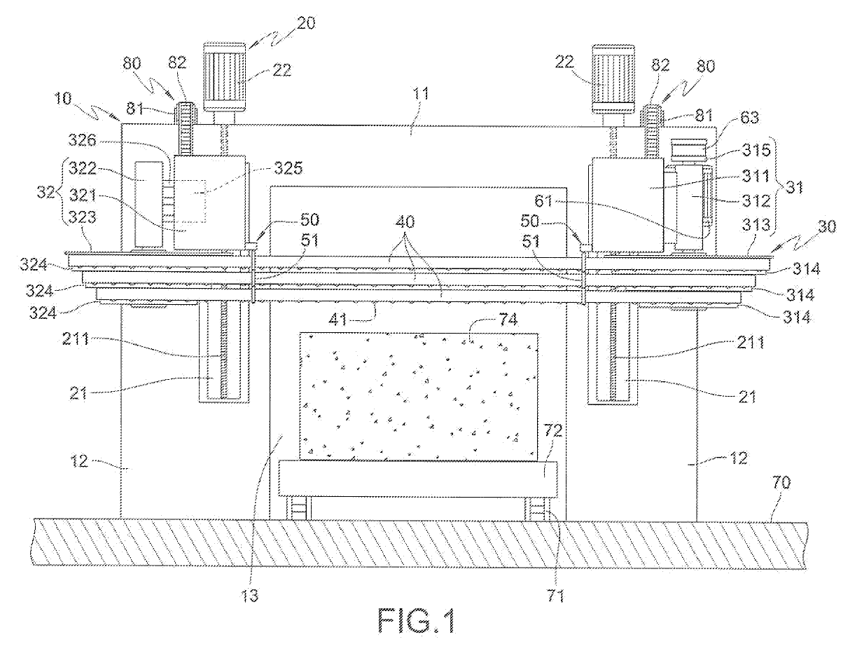

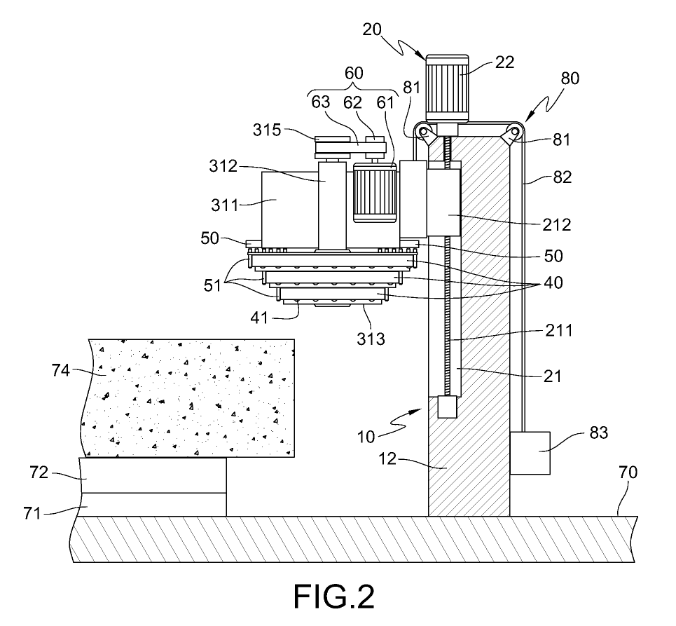

Referring to FIGS. 1 and 2, the multi-bandsaw machine in a first embodiment of the present invention is a horizontal multi-bandsaw machine, which comprises a machine body 10, an elevator mechanism 20, a bandsaw wheelset 30, a plurality of bandsaws 40, a plurality of guide wheelsets 50, a power mechanism 60, and two counterweight devices 80. The machine body 10 has a platform 11 and two fixing posts 12. The fixing posts 12 are symmetrically disposed on two opposite sides of the platform 11, for example, on the left and right sides of the platform 11. One end of each fixing post 12 is connected to the platform 11, and the other end is supported on a plane 70, so that an accommodating space 13 is formed between the platform 11 and the plane 70 (for example, the ground or a working platform).

The elevator mechanism 20 has two elevating bases 21 and two elevating motors 22. The two elevating bases 21 are respectively disposed on the two fixing posts 12, and partially embedded in the fixing posts 12. Each elevating base 21 has a screw rod 211 and a slide block 212. One end of the screw rod 211 penetrates the elevating base 21, and the other end protrudes from the other side of the platform 11 opposite to the fixing posts 12. The slide block 212 is fit on the end of the screw rod 211 penetrating the elevating base 21. A nut (not shown) is annularly disposed on a contact surface between the slide block 212 and the screw rod 211, and the nut matches with the thread on the screw rod 211. The two elevating motors 22 are disposed on the other side of the platform 11 opposite to the two fixing posts 12, and respectively connected to the ends of the two screw rods 211 protruding from the platform 11.

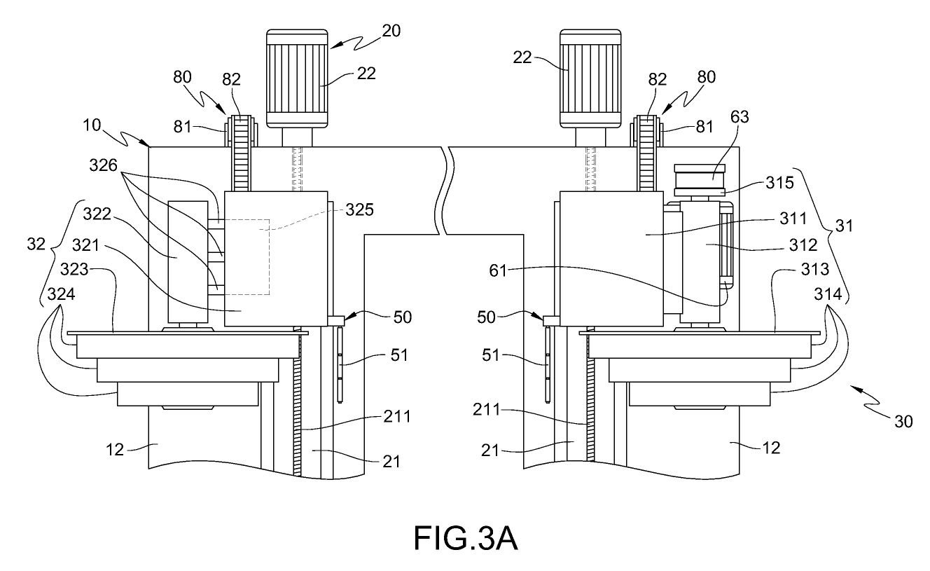

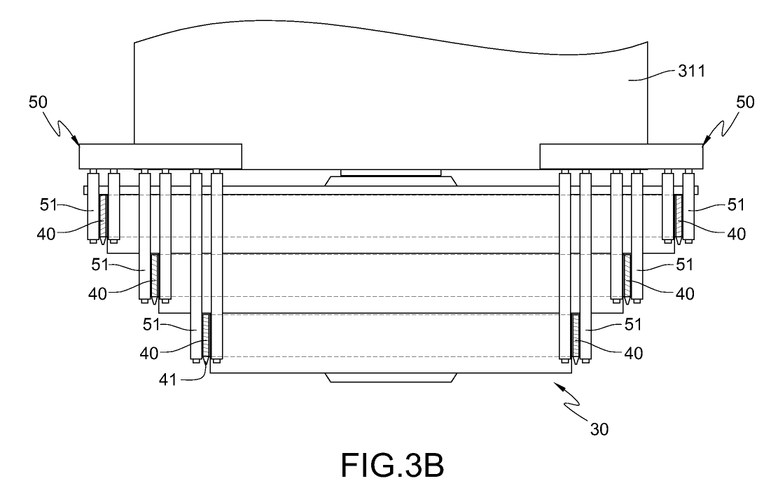

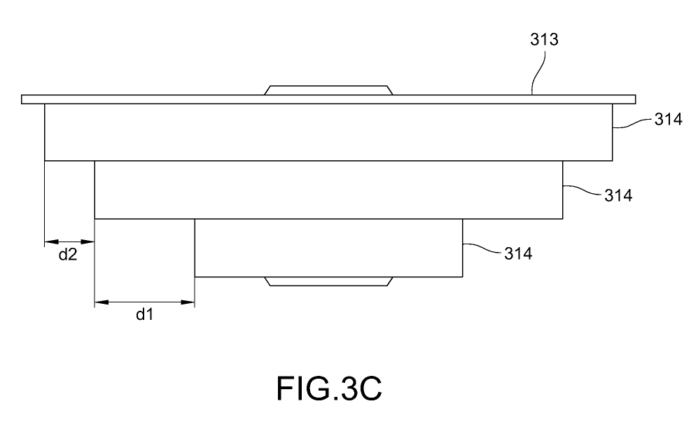

Referring to FIG. 3A, the bandsaw wheelset 30 has a first bandsaw wheel 31 and a second bandsaw wheel 32. The first bandsaw wheel 31 and the second bandsaw wheel 32 are respectively disposed corresponding to the two fixing posts 12 on the machine body 10. The first bandsaw wheel 31 and the second bandsaw wheel 32 respectively have a body 311, 321, a rotating shaft 312, 322, and a rotating disc 313, 323. One side of the body 311, 321 is connected to the slide block 212 of one of the elevating bases 21 (as shown in FIG. 2), so that the bandsaw wheelset 30 is horizontally disposed between the platform 11 and the plane 70 in a direction parallel to the plane 70 (as shown in FIGS. 1 and 2), and a distance between the rotating disc 313 of the first bandsaw wheel 31 and the plane 70 is equal to that between the rotating disc 323 of the second bandsaw wheel 32 and the plane 70. The rotating shaft 312, 322 is respectively connected to the other side of the body 311, 321, and one end of the rotating shaft 312, 322 penetrates the rotating disc 313, 323. The other end of the rotating shaft 312 of the first bandsaw wheel 31 opposite to the rotating disc 313 has a belt pulley 315.

A plurality of sleeve joint portions 314, 324 of different diameters is annularly disposed on the rotating discs 313, 323. In this embodiment, the rotating discs 313, 323 respectively have three sleeve joint portions 314, 324, and the number of the sleeve joint portions 314, 324 may be set as two, four, or others upon actual requirements, which is not limited herein. The sleeve joint portions 314, 324 of different diameters are integrally formed on the rotating discs 313, 323, and respectively constitute a step-like structure on the rotating discs 313, 323, as shown in FIG. 3A. The diameters of the sleeve joint portions 314, 324 are respectively decreased from one side of the rotating discs 313, 323 opposite to the platform 11 to the other side of the rotating discs 313, 323.

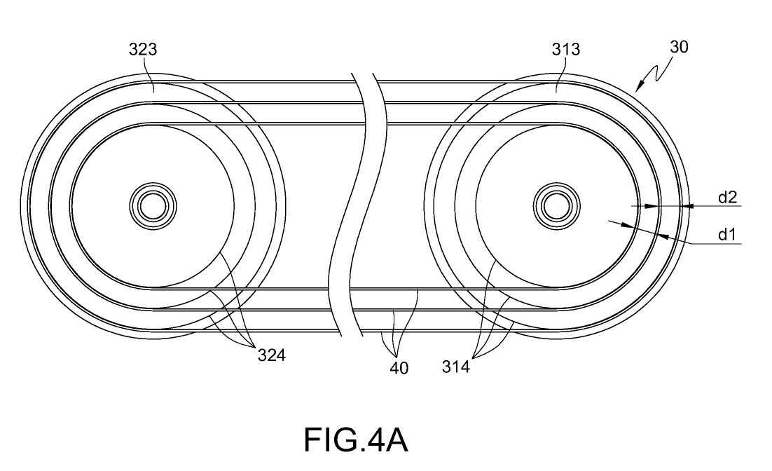

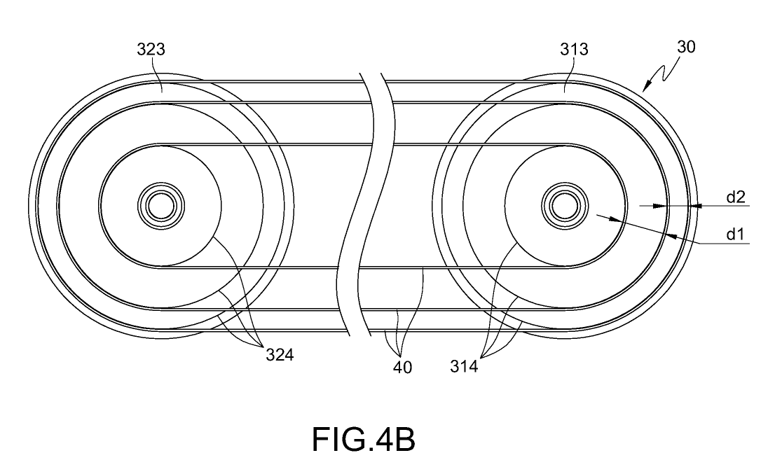

Referring to FIGS. 3A and 4A, the sleeve joint portions 314, 324 respectively disposed on the rotating discs 313, 323 are spaced by the same distances d1, d2. Taking the first bandsaw wheel 31 for example, the sleeve joint portions 314 are spaced from each other by two equal distances d1, d2 on the rotating disc 313 of the first bandsaw wheel 31, i.e., the distance d1 is equal to the distance d2.

The bandsaws 40 are diamond bandsaws. Specifically, a plurality of diamond grits 41 (as shown in FIG. 2) is electroplated on at least one of two opposite side edges of each bandsaw 40 parallel to the plane 70, so as to form a cutting surface of the bandsaw 40. The bandsaws 40 are respectively fit on the corresponding sleeve joint portions 314, 324 of the first bandsaw wheel 31 and the second bandsaw wheel 32. That is, the two ends of each bandsaw 40 are respectively fit on the sleeve joint portions 314, 324 of the same diameter on the first bandsaw wheel 31 and the second bandsaw wheel 32 (as shown in FIG. 1), and thus the bandsaws 40 are disposed above the accommodating space 13. In this embodiment, the first bandsaw wheel 31 and the second bandsaw wheel 32 respectively have three sleeve joint portions 314, 324, and the number of the bandsaws 40 is corresponding to that of the sleeve joint portions 314, 324, so as to form a three-bandsaw machine after fitting on the bandsaws. In addition, the two ends of each bandsaw 40 may also be respectively fit on the sleeve joint portions 314, 324 of different diameters on the first bandsaw wheel 31 and the second bandsaw wheel 32, such that the sleeve joint portions 314, 324 of different diameters rotate to accelerate the revolving of the bandsaw 40 between the first bandsaw wheel 31 and the second bandsaw wheel 32.

Meanwhile, a tension controller 325 is disposed on the body 321 of the second bandsaw wheel 32, and has a plurality of push rods 326. One end of each push rod 326 is movably disposed on the tension controller 325, and the other end is connected to the rotating shaft 322 of the second bandsaw wheel 32. The tension controller 325 drives the push rods 326 to draw or push against the rotating shaft 322 by means of oil pressure or hydraulic pressure, such that the rotating shaft 322 of the second bandsaw wheel 32 forces the rotating disc 323 to approach to or move away from the body 321, so as to adjust the tightness (i.e., the bandsaw tension) of the bandsaws 40 between the first bandsaw wheel 31 and the second bandsaw wheel 32. For example, when the push rods 326 of the tension controller 325 push against the rotating shaft 322 to make the rotating disc 323 apart from the body 321, the bandsaws 40 are tightly pressed against the sleeve joint portions 314, 324 of the first bandsaw wheel 31 and the second bandsaw wheel 32, thus preventing the bandsaws 40 from falling off the bandsaw wheelset 30.

Referring to FIG. 3B, the guide wheelsets 50 are respectively disposed on the bodies 311, 321 of the first bandsaw wheel 31 and the second bandsaw wheel 32, and each guide wheelset 50 has a plurality of rollers 51. The rollers 51 are press-fit on a band surface of each bandsaw 40, so as to guide the rotation of the bandsaws 40 between the first bandsaw wheel 31 and the second bandsaw wheel 32, and control the positioning of the bandsaws 40 when the first bandsaw wheel 31 and the second bandsaw wheel 32 are in rotation.

Further referring to FIGS. 1 and 2, the power mechanism 60 may be disposed on either the first bandsaw wheel 31 or the second bandsaw wheel 32, or on both the first bandsaw wheel 31 and the second bandsaw wheel 32. In this embodiment, to ease the illustration, the power mechanism 60 is, for example, disposed on the first bandsaw wheel 31, and the present invention is not limited thereto. The power mechanism 60 has a drive motor 61, a drive pulley 62, and a belt 63. The drive motor 61 is connected to the body 311 of the first bandsaw wheel 31, and adjacent to one side of the rotating shaft 312. The drive pulley 62 is disposed on one end of the drive motor 61, and connected to the belt pulley 315 of the rotating shaft 312 through the belt 63. Two ends of the belt 63 are respectively fit on the drive pulley 62 of the drive motor 61 and the belt pulley 315 of the rotating shaft 312. Thereby, the drive motor 61 drives the drive pulley 62 to rotate, and the belt pulley 315 on the rotating shaft 312 is forced by the belt 63 to propel the first bandsaw wheel 31 to rotate.

The two counterweight devices 80 are symmetrically disposed on two ends of the machine body 10, and each counterweight device 80 has a pulley block 81 and a chain 82. The pulley block 81 may have a single pulley or a plurality of pulleys. In this embodiment, the pulley block 81 formed by two pulleys is disposed on the platform 11 at a position adjacent to the elevating motor 22. The chain 82 is disposed across and rested on the two pulleys 81. The chains 82 of the two counterweight devices 80 are respectively connected to the bodies 311, 321 of the first bandsaw wheel 31 and the second bandsaw wheel 32. A counterweight block 83 is disposed on the other end of each chain 82, for adjusting the positioning of the first bandsaw wheel 31 and the second bandsaw wheel 32 between the machine body 10 and the plane 70.

Referring to FIGS. 1, 2, and 5, during the cutting process of the stone material, the horizontal multi-bandsaw machine in the first embodiment of the present invention is disposed on the plane 70, the plane 70 has a slide rail 71 penetrating the accommodating space 13, and the slide rail 71 carries a trolley 72 for delivering the stone material 74. Before the trolley 72 delivers the stone material 74 through the accommodating space 13, the drive motor 61 of the power mechanism 60 is started, so that the rotating shaft 312 of the first bandsaw wheel 31 propels the rotating disc 313 to rotate through the belt 63, and also drive the bandsaws 40 fit on the sleeve joint portion 314 to revolve between the first bandsaw wheel 31 and the second bandsaw wheel 32, thereby drawing the second bandsaw wheel 32 to rotate. Meanwhile, due to the guide and positioning of the guide wheelsets 50, the bandsaws 40 are driven by the drive motor 61 to rotate stably in a single direction at a tangential speed of 15 to 50 m/s between the first bandsaw wheel 31 and the second bandsaw wheel 32, for example, rotate at a tangential speed of 20 to 40 m/s or 30 to 40 m/s.

Then, the elevating motors 22 of the elevator mechanism 20 are started to drive the screw rods 211 connected thereto to rotate, and thus the slide block 212 fit on each screw rod 211 is forced to make a synchronous displacement. Moreover, as the bodies 311, 321 of the first bandsaw wheel 31 and the second bandsaw wheel 32 are respectively connected to the slide blocks 212 on the screw rods 211, when the elevating motors 22 are started, the first bandsaw wheel 31 and the second bandsaw wheel 32 are propelled to make synchronous to-and-fro displacements between the platform 11 and the plane 70, and the first bandsaw wheel 31 and the second bandsaw wheel 32 remain at the same level between the platform 11 and the plane 70. Further, in accordance with the adjustment of the counterweight blocks 83 of the counterweight devices 80, the weights of the first bandsaw wheel 31 and the second bandsaw wheel 32 are adjusted, so as to make the bandsaws 40 remain in parallel with the plane 70 between the machine body 10 and the stone material 74.

In addition, a connecting device (not shown) may also be disposed between the body 311 of the first bandsaw wheel and the body 321 of the second bandsaw wheel, for example, a connecting rod or a connecting plate, such that the body 311 of the first bandsaw wheel and the body 321 of the second bandsaw wheel are connected via the connecting device, so as to enhance the stability of the synchronous displacement of the first bandsaw wheel 31 and the second bandsaw wheel 32 between the platform 11 and the plane 70.

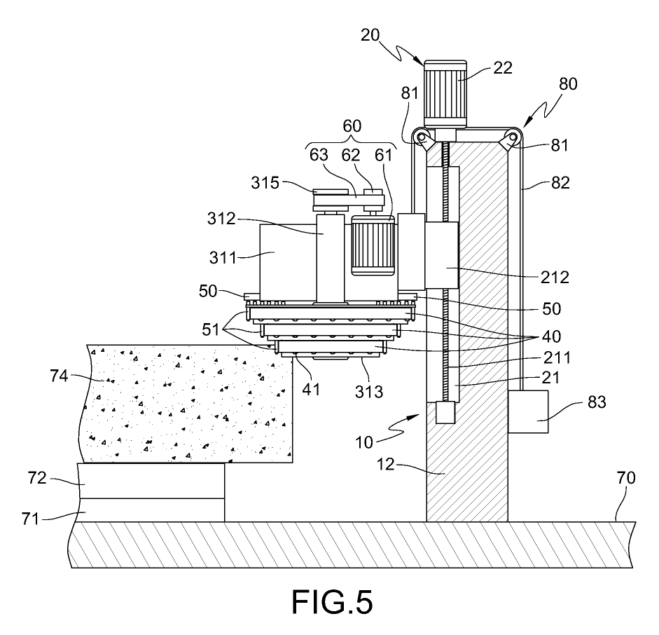

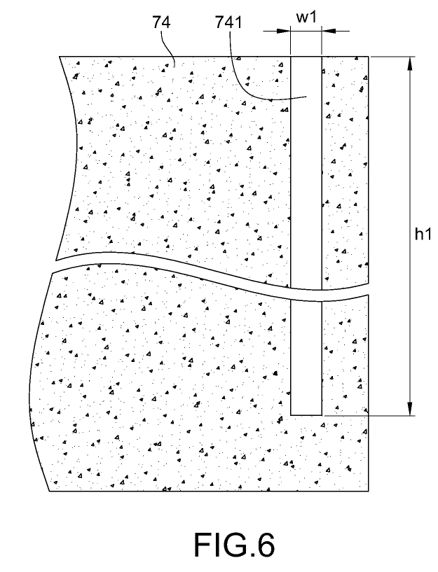

Next, referring to FIG. 5, the trolley 72 delivers the stone material 74 into the accommodating space 13, and is positioned below the bandsaws 40. The elevator mechanism 20 propels the bandsaw wheelset 30 to move toward the stone material 74, and make the bandsaws 40 contact the stone material 74, so as to enable the diamond grits 41 on the bandsaws 40 to cut the stone material 74. Referring to FIG. 6, when the bandsaws 40 cut into the stone material 74 at a speed of 70 to 360 cm/h, a cutting notch 741 is formed on the stone material 74, and the cutting speed may be adjusted according to the type of the stone material 74. For example, when the stone material is granite with a hard texture, the bandsaws 40 cut the granite at a speed of 70 to 120 cm/h to obtain a granite plate having a thickness of 3 to 20 mm. When the stone material is marble with a soft texture, the bandsaws 40 cut the marble at a speed of 210 to 360 cm/h to obtain a desired marble plate. The above content is an example for illustration only, instead of limiting the type of the stone material and the cutting speed of the present invention.

Moreover, when the bandsaws 40 cut the stone material 74, the cutting notch made by the bandsaws 40 on the stone material 74 has a depth h1 and a width w1 with a ratio (depth to kerf ratio, h1/w1) at least larger than 100:1 in each hour. That is, if the width w1 of the cutting notch is 1.8 to 2.5 mm, for example, 2.2 mm, the depth h1 of the cutting notch formed by the bandsaws 40 cutting into the stone material 74 is at least 440 mm, and the depth to kerf ratio remains larger than 200:1 in each hour till obtaining a stone plate from the stone material 74. Therefore, when the bandsaws 40 cut the granite at a speed of 70 to 120 cm/h, the cutting notch 741 made by the bandsaws 40 on the granite has a depth to kerf ratio in a range of 280:1 (70 cm/2.5 mm) to 667:1 (120 cm/1.8 mm). When the bandsaws 40 cut the marble at a speed of 210 to 360 cm/h, the cutting notch 741 made by the bandsaws 40 on the marble has a depth to kerf ratio in a range of 840:1 (210 cm/2.5 mm) to 2000:1 (360 cm/1.8 mm). The above content is an example for illustration only, instead of limiting the present invention.

As the multi-bandsaw machine of the present invention cuts the stone material 74 with several bandsaws 40 at the same time, a plurality of stone plates (not shown) is obtained when the elevator mechanism 20 propels the bandsaws 40 to cut the stone material 74 in a single process, thereby accelerating the cutting speed of the stone material 74. Moreover, due to the distances between the bandsaws 40 as well as the tangential speed of the bandsaws 40 in accordance with the cutting speed, the cut stone plate has a thickness of 3 to 20 mm, for example, 3 mm, 5 mm, 10 mm, 12 mm, or 18 mm.

Meanwhile, for a common to-and-fro drag-saw machine generally used for cutting a stone material, limited by the length of the drag-saw during the cutting process, the drag-saw has to be held up for a while when reaching a set point, and then starts moving to the opposite direction. Therefore, when cutting a stone material, the drag-saw will pause for a while at two set points in two opposite directions, resulting in a delay of the cutting process. However, for the multi-bandsaw machine in the first embodiment of the present invention, as the bandsaws rotate in a single direction at a tangential speed of 20 to 40 m/s, for example, in a clockwise or anticlockwise direction, the cutting process of the stone material 74 may not be restricted by the length of the bandsaws, and no delay will be caused, so that the cutting efficiency of the bandsaws on the stone material is significantly improved.

In addition, when a bandsaw machine or drag-saw machine is used for cutting a stone material, as the bandsaw (or drag-saw) goes deeper and deeper in the stone material, the cutting notch made by the bandsaw (or drag-saw) on the stone material also becomes increasingly wider. For example, when the bandsaw (or drag-saw) is 100 mm deep cut into the stone material, a cutting notch with a width of 2 mm is formed, and the larger the width of the cutting notch is, the more waste of the stone material made by the bandsaw (or drag-saw) will be. Besides, in each cutting process, a part of the stone material is wasted, and the number of the stone plates that can be produced from a single stone material is largely reduced, so that the utilization of the stone material is reduced and the cost is increased. However, for the multi-bandsaw machine in the first embodiment of the present invention, during the cutting process of the stone material, when the bandsaws cut into the stone material, the cutting depth and width made by the bandsaws in the stone material are maintained at a depth to kerf ratio larger than 100:1 in each hour, and the cutting notch made by the bandsaw on the stone material has a width of about 2.2 mm. Therefore, the waste of the stone material made by the bandsaws is significantly reduced, and the number of the stone plates that can be produced from a single unit of the stone material is increased, thus lowering the manufacturing cost of the stone plates.

Referring to FIG. 3C, in the first embodiment of the present invention, a plurality of stone plates having the same thickness can be obtained from the stone material 74 in a single process, and a plurality of stone plates having different thicknesses may also be obtained from the stone material 74 in a single process by changing the diameters of the sleeve joint portions 314, 324 of the first bandsaw wheel 31 and the second bandsaw wheel 32.

Further, referring to FIGS. 3C and 4B, by changing the diameters of the sleeve joint portions 314, 324, the sleeve joint portions 314, 324 disposed on the rotating discs 313, 323 are spaced from each other by two different distances d1, d2, for example, d1>d2. Thus, when the bandsaws 40 cut the stone material 74, a plurality of stone plates having different thicknesses are obtained in a single process.

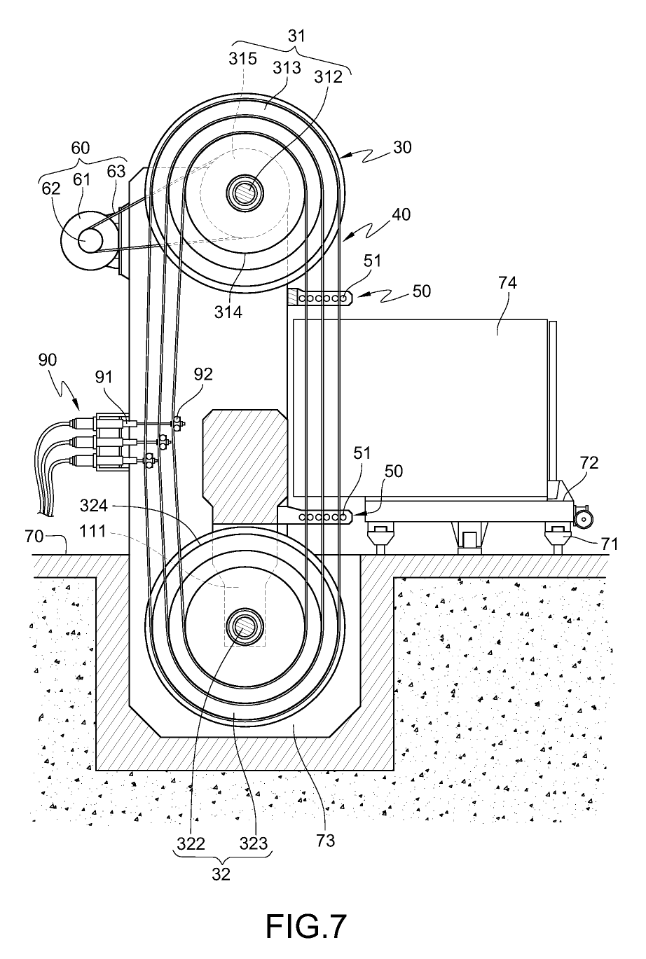

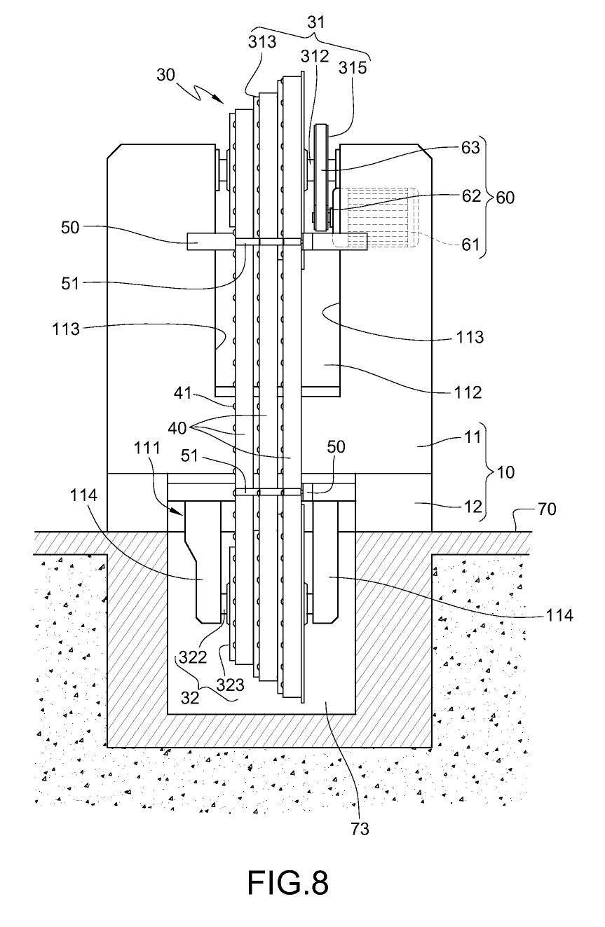

FIGS. 7 and 8 are respectively a schematic front view and a schematic side view of a second embodiment of the present invention. The multi-bandsaw machine in the second embodiment of the present invention is a vertical multi-bandsaw machine, which comprises a machine body 10, a bandsaw wheelset 30, a plurality of bandsaws 40, two guide wheelsets 50, a power mechanism 60, and a bandsaw tension controller 90. The machine body 10 has a platform 11 and a fixing post 12. The platform 11 is connected to one side of the fixing post 12, and one end of the fixing post 12 is disposed on the ground or on a plane 70 such as a working platform. The plane 70 has a groove 73. The platform 11 has a support frame 111 on one side opposite to the groove 73, the support frame 111 extends into the groove 73, and the platform 11 has a gap 112 on the other side opposite to the groove 73.

The bandsaw wheelset 30 has a first bandsaw wheel 31 and a second bandsaw wheel 32, the first bandsaw wheel 31 and the second bandsaw wheel 32 respectively have a rotating shaft 312, 322 and a rotating disc 313, 323, and a plurality of sleeve joint portions 314, 324 of different diameters is annularly disposed on the rotating discs 313, 323, so that the rotating discs 313, 323 respectively form a step-like structure. In this embodiment, the rotating discs 313, 323 respectively have three sleeve joint portions 314, 324, and the number of the sleeve joint portions 314, 324 may be altered upon actual requirements. The first bandsaw wheel 31 and the second bandsaw wheel 32 are disposed perpendicular to the plane 70 on the machine body 10, the rotating shaft 312 of the first bandsaw wheel 31 penetrates the rotating disc 313, and two ends of the rotating shaft 312 are respectively movably disposed on two opposite sidewalls 113 in the gap 112 of the platform 11, such that the first bandsaw wheel 31 may rotate in the gap 112 via the rotating shaft 312. Besides, a belt pulley 315 is fit on one end of the rotating shaft 312.

The second bandsaw wheel 32 is disposed in the groove 73 of the plane 70, the rotating shaft 322 of the second bandsaw wheel 32 penetrates the rotating disc 323, and two ends of the rotating shaft 322 are respectively movably disposed on two opposite support arms 114 of the support frame 111, such that the second bandsaw wheel 32 may rotate on the support frame 111 via the rotating shaft 322. Therefore, the bandsaw wheelset 30 is disposed perpendicular to the plane 70 on the machine body 10.

Further referring to FIGS. 7 and 8, the bandsaws 40 are diamond bandsaws. Specifically, a plurality of diamond grits 41 is electroplated on at least one of two opposite side edges of each bandsaw 40 parallel to the plane 70, so as to form a cutting surface of the bandsaws 40. The bandsaws 40 are respectively fit on the corresponding sleeve joint portions 314, 324 of the first bandsaw wheel 31 and the second bandsaw wheel 32, and the two ends of each bandsaw 40 are respectively fit on the sleeve joint portions 314, 324 of the same diameter on the first bandsaw wheel 31 and the second bandsaw wheel 32, so that the bandsaws 40 are perpendicular to the plane 70.

The two guide wheelsets 50 are respectively disposed on the platform 11 at positions adjacent to the first bandsaw wheel 31 and the second bandsaw wheel 32, and each guide wheelset 50 has a plurality of rollers 51. The rollers 51 are press-fit on a band surface of each bandsaw 40, so as to guide the rotation of the bandsaws 40 between the first bandsaw wheel 31 and the second bandsaw wheel 32.

The power mechanism 60 may be disposed on the platform 11 at a position adjacent to either the first bandsaw wheel 31 or the second bandsaw wheel 32, or at positions respectively adjacent to the first bandsaw wheel 31 and the second bandsaw wheel 32. In this embodiment, to ease the illustration, the power mechanism 60 is, for example, disposed on the platform 11 at a position adjacent to the first bandsaw wheel 31, and the present invention is not limited thereto. The power mechanism 60 has a drive motor 61, a drive pulley 62, and a belt 63. The drive pulley 62 is disposed on one end of the drive motor 61, and connected to the rotating shaft 312 through the belt 63. Two ends of the belt 63 are respectively fit on the drive pulley 62 of the drive motor 61 and the belt pulley 315 of the rotating shaft 312. Thereby, the drive motor 61 drives the drive pulley 62 to rotate, and the belt pulley 315 on the rotating shaft 312 is forced by the belt 63 to propel the first bandsaw wheel 31 to rotate.

The bandsaw tension controller 90 is disposed on one side of the machine body 10 adjacent to the bandsaws, and has a plurality of pull rods 91. One end of each pull rod 91 is movably disposed on the bandsaw tension controller 90, and the other end has a column 92. The columns 92 are respectively hooked on the bandsaws 40. The bandsaw tension controller 90 drives the pull rods 91 by means of oil pressure, hydraulic pressure, or gravity. In this embodiment, the pull rods 91 are driven by oil pressure to propel the columns 92 to draw the bandsaws 40, such that the bandsaws 40 are closely attached to the sleeve joint portions 314, 324 of the first bandsaw wheel 31 and the second bandsaw wheel 32 due to the increase of the tension.

Referring to FIG. 7, the multi-bandsaw machine in the second embodiment of the present invention is disposed on the plane 70, and a slide rail 71 that carries a trolley 72 for delivering the stone material 74 is disposed on the plane 70 at a position adjacent to the multi-bandsaw machine. During the cutting process of the stone material 74, the drive motor 61 of the power mechanism 60 is started to drive the first bandsaw wheel 31 to rotate, so that the bandsaws 40 and the second bandsaw wheel 32 are both propelled by the first bandsaw wheel 31 to rotate. Besides, guided by the guide wheelsets 50, the bandsaws 40 are driven by the drive motor 61 to revolve in a single direction at a tangential speed of 15 to 50 m/s between the first bandsaw wheel 31 and the second bandsaw wheel 32, for example, revolve at a tangential speed of 30 to 40 m/s. Meanwhile, due to the positioning of the guide wheelset 50, the bandsaws 40 are driven by the drive motor 61 to rotate stably on the bandsaw wheelset 30. Next, the trolley 72 delivers the stone material 74 to pass through the bandsaws 40 in rotation, and the stone material 74 is cut by the bandsaws 40 into a plurality of stone plates (not shown) having a thickness of 3 to 20 mm, for example, 3 mm, 5 mm, 10 mm, 12 mm, or 18 mm.

In addition, during the cutting process of the stone material, when the bandsaws 40 contact the stone material 74, a cutting notch (not shown) having a width of 1.8 to 2.5 mm (for example, 2.2 mm) is made by the bandsaws 40 on the stone material 74. The bandsaws 40 cut into the stone material 74 at a speed of 70 to 360 cm/h, and the cutting speed may be adjusted according to the type of the stone material 74. For example, when the stone material 74 is granite, the cutting speed is in a range of 70 to 120 cm/h, and when the stone material 74 is marble, the cutting speed is in a range of 210 to 360 cm/h. Moreover, during the cutting process, a ratio between the depth of the bandsaws 40 cutting into the stone material 74 and the width of the cutting notch made by the bandsaws 40 on the stone material 74 (i.e., depth to kerf ratio) is at least larger than 100:1 in each hour. That is to say, if the width of the cutting notch is 2.2 mm, the depth of the bandsaws 40 cutting into the stone material 74 is at least 440 mm, and the depth to kerf ratio remains larger than 200:1 in each hour till obtaining a stone plate from the stone material 74.

The multi-bandsaw machine provided by the present invention has a plurality of sleeve joint portions of different diameters on two symmetrically disposed bandsaw wheels, and the bandsaws are fit on the sleeve joint portions, such that the multi-bandsaw machine is capable of cutting metal, wood, stone, or other materials into a plurality of plates in a single process, in which the obtained plates may have the same thickness or different thicknesses. Thereby, the operating times of the cutting process is reduced and the cutting efficiency is enhanced, so as to lower the operating cost of the process. Meanwhile, the diameters of the sleeve joint portions may be changed to selectively control the thickness of the plates, and the obtained plates may have the same thickness.

Moreover, when the multi-bandsaw machine of the present invention is used for cutting a material, as the cutting notch made by the bandsaws on the material has a depth to kerf ratio maintained larger than 100:1 in each hour, the waste of the material is significantly reduced, the utilization of the material is improved, and the manufacturing cost of the plates is also lowered.

What is claimed is:

1. A multi-bandsaw machine, adapted to cut a material into a plurality of plates in a single process, wherein the multi-bandsaw machine has several bandsaws rotating in a single direction, and a plurality of diamond grits is disposed on at least one of two opposite side edges of each bandsaw, so that the bandsaws cut the material with the diamond grits and form a cutting notch on the material, and the cutting notch has a depth to kerf ratio larger than 100:1 during the process of cutting the material with the diamond grits in each hour.

2. The multi-bandsaw machine according to claim 1, wherein the multi-bandsaw machine is a horizontal processing mechanism, and further comprises:
a machine body, disposed on a plane, and having two fixing posts, wherein the two fixing posts are symmetrically disposed on two opposite sides of the machine body, one end of each fixing post is connected to the machine body, and the other end is supported on the plane;
a bandsaw wheelset, having a first bandsaw wheel and a second bandsaw wheel respectively disposed corresponding to the two fixing posts, wherein the first bandsaw wheel and the second bandsaw wheel respectively have a plurality of sleeve joint portions of different diameters, and two ends of each bandsaw are respectively fit on the sleeve joint portions of the first bandsaw wheel and the second bandsaw wheel;
an elevator mechanism, disposed on the machine body, and connected to the bandsaw wheelset, for driving the bandsaw wheelset to make to-and-fro displacements between the machine body and the plane, so as to enable the bandsaws to move in a direction perpendicular to the plane; and
at least one power mechanism, disposed on the bandsaw wheelset, for driving the first bandsaw wheel and the second bandsaw wheel to rotate, so as to enable the bandsaws to rotate in a single direction parallel to the plane between the first bandsaw wheel and the second bandsaw wheel.

3. The multi-bandsaw machine according to claim 2, wherein the elevator mechanism comprises:
two elevating bases, respectively disposed on the two fixing posts of the machine body, and each having a screw rod and a slide block, wherein one end of the screw rod penetrates the elevating base, and the other end protrudes from the elevating base, the slide block is fit on the end of the screw rod penetrating the elevating base, and one side of the slide block is connected to the bandsaw wheelset; and
two elevating motors, respectively connected to the ends of the screw rods protruding from the two elevating bases, for driving the screw rods to rotate, so as to enable the slide blocks to make to-and-fro displacements between the machine body and the plane.

4. The multi-bandsaw machine according to claim 3, wherein the first bandsaw wheel and the second bandsaw wheel of the bandsaw wheelset further respectively comprise:
a body, having one side connected to the slide block of one of the two elevating bases, so that the slide block propels the body to make to-and-fro displacements between the machine body and the plane;
a rotating disc, wherein the sleeve joint portions of different diameters are disposed on the rotating disc; and
a rotating shaft, disposed on one side of the body, wherein one end of the rotating shaft opposite to the plane penetrates the rotating disc.

5. The multi-bandsaw machine according to claim 4, wherein the power mechanism has a drive motor disposed on the body of the first bandsaw wheel, and the drive motor is connected to the rotating shaft of the first bandsaw wheel, so as to drive the rotating shaft to propel the rotating disc of the first bandsaw wheel to rotate.

6. The multi-bandsaw machine according to claim 4, wherein the body of the second bandsaw wheel further comprises a tension controller, the tension controller has a plurality of push rods movably disposed thereon, and one end of each push rod is connected to the rotating shaft of the second bandsaw wheel, so that the tension controller drives the push rods to draw or push against the rotating shaft, and thus the rotating shaft of the second bandsaw wheel forces the rotating disc to approach to or move away from the body.

7. The multi-bandsaw machine according to claim 2, further comprising two counterweight devices symmetrically disposed on two ends of the machine body, wherein each counterweight device has a pulley block and a chain, the pulley block is fixed to the other side of the machine body opposite to the two fixing posts, the chain is disposed across and rested on the pulley block, one end of the chain is connected to the bandsaw wheelset, and the other end has a counterweight block, so as to draw the bandsaw wheelset to make a displacement between the machine body and the plane.

8. The multi-bandsaw machine according to claim 1, wherein the number of the bandsaws is three.

9. The multi-bandsaw machine according to claim 1, wherein the bandsaws rotate in a single direction at a tangential speed of 15 to 50 m/s.

10. The multi-bandsaw machine according to claim 1, wherein the diamond grits are electroplated on at least one of the two opposite side edges of each bandsaw parallel to the plane.

11. The multi-bandsaw machine according to claim 1, wherein the thickness of the plate is 1 to 20 mm.

12. The multi-bandsaw machine according to claim 11, wherein the thickness of the plate is 3 mm.

13. The multi-bandsaw machine according to claim 1, wherein the multi-bandsaw machine cuts the material into a plurality of plates at a speed of 70 to 360 cm/h.

14. The multi-bandsaw machine according to claim 13, wherein the multi-bandsaw machine cuts the material at a speed of 70 to 120 cm/h.

15. The multi-bandsaw machine according to claim 13, wherein the multi-bandsaw machine cuts the material at a speed of 210 to 360 cm/h.

16. The multi-bandsaw machine according to claim 13, wherein the multi-bandsaw machine cuts the material and forms a cutting notch having a width of 1.8 to 2.5 mm on the material.

17. The multi-bandsaw machine according to claim 16, wherein the width is 2.2 mm.

18. The multi-bandsaw machine according to claim 1, wherein the multi-bandsaw machine is a vertical processing mechanism, and further comprises:
a machine body, disposed a plane, and having a gap and a support frame, wherein the support frame is disposed on one side of the machine body opposite to the plane, and the gap is disposed on the other side of the machine body opposite to the support frame;
a bandsaw wheelset, having a first bandsaw wheel and a second bandsaw wheel, wherein the first bandsaw wheel is movably disposed in the gap, and the second bandsaw wheel is movably disposed on the support frame, so that the bandsaw wheelset is fixed to the machine body in a direction perpendicular to the plane, the first bandsaw wheel and the second bandsaw wheel respectively have a plurality of sleeve joint portions of different diameters, and two ends of each bandsaw are respectively fit on the sleeve joint portions of the first bandsaw wheel and the second bandsaw wheel; and
at least one power mechanism, disposed on the machine body, for driving the first bandsaw wheel and the second bandsaw wheel to rotate, so as to enable the bandsaws to rotate in a single direction perpendicular to the plane between the first bandsaw wheel and the second bandsaw wheel.

19. The multi-bandsaw machine according to claim 18, wherein the power mechanism has a drive motor disposed on one side of the machine body adjacent to the first bandsaw wheel, and the drive motor is connected to the first bandsaw wheel, so as to drive the first bandsaw wheel to rotate in the gap.

20. The multi-bandsaw machine according to claim 2, further comprising a plurality of guide wheelsets connected to the bandsaw wheelset, wherein each guide wheelset has a plurality of rollers, and the rollers are press-fit on the bandsaws, so as to guide the rotation of the bandsaws between the first bandsaw wheel and the second bandsaw wheel.

21. The multi-bandsaw machine according to claim 18, further comprising a plurality of guide wheelsets connected to the bandsaw wheelset, wherein each guide wheelset has a plurality of rollers, and the rollers are press-fit on the bandsaws, so as to guide the rotation of the bandsaws between the first bandsaw wheel and the second bandsaw wheel.

22. The multi-bandsaw machine according to claim 2, wherein the sleeve joint portions are integrally formed on the first bandsaw wheel and the second bandsaw wheel, respectively.

23. The multi-bandsaw machine according to claim 18, wherein the sleeve joint portions are integrally formed on the first bandsaw wheel and the second bandsaw wheel, respectively.

24. The multi-bandsaw machine according to claim 18, further comprising a bandsaw tension controller, wherein the bandsaw tension controller is disposed on one side of the machine body adjacent to the bandsaws and has a plurality of pull rods movably disposed thereon, one end of each pull rod is movably disposed on the bandsaw tension controller, and the other end has a column, the columns are respectively hooked on the bandsaws, and the bandsaw tension controller drives the pull rods to draw the bandsaws, so as to make the bandsaws closely attached to the sleeve joint portions.
